(19) United States
(12) Patent Application Publication
(10) Pub. No.: US 2007/0214480 A1
(43) Pub. Date: Sep. 13, 2007

(54) Method and apparatus for conducting media content search and management by integrating EPG and internet search systems

(76) Inventor: Yakov Kamen, Cupertino, CA (US)

Correspondence Address: Yakov Kamen, 19334 Greenwood Drive, Cupertino, CA, 95014, US

(21) Appl. No.: 11/369,537

(22) Filed: Mar. 8, 2006

(51) Int. Cl. H04N 5/445; G06F 3/00; G06F 13/00; H04N 7/173

(52) U.S. Cl. 725/53; 725/51; 725/52; 725/112; 725/113

(57) ABSTRACT

A media schedule search system in accordance with the invention combines together EPG search capabilities with Internet engine search capabilities. In one embodiment of this invention we propose to build Internet EPG system that uses EPG guide data as a basis for set of automatically generated search criteria for the Internet search system. In one embodiment of this invention search results are used for enhancing event description. In one embodiment of this invention we propose to build an EPG network system that uses EPG as a TV data search engine enhancement.

### CROSS-REFERENCE TO RELATED APPLICATIONS

This application claims the benefit of provisional patent YKA005GDSRH022005 filed 2005 Mar. 05 by the present inventor

### FEDERALLY SPONSORED RESEARCH

Not applicable

### SEQUENCE LISTING OF PROGRAM

Not applicable

### BACKGROUND OF THE INVENTION

The present invention pertains to technology of media content search, particularly to TV content search.

Media content (movies, pictures, videos, songs, etc.) is often associated with multiple content descriptions called content metadata. Content metadata can be text or media. It can be stored at specific secure locations or distributed around the network. In one embodiment media content is a set of TV programs or events and content metadata is a set of event descriptions available electronically. Such “electronically available” content metadata can be separated into two categories:
“Guide data” is a category aggregated by experts in the field. This data usually requires manual processing in order to deliver the maximum information using minimal descriptions. A good example of guide data in the TV media field is schedule data in TV Guide magazine. Guide data for TV media is used to announce TV schedules in printed form (magazines, newspapers) or electronic form (Electronic Programming Guide, or EPG). Guide data can be transferred to and stored in multiple electronic devices, including PCs, TVs, set-top-boxes, mobile phones, etc.
The other category we call “network data” which is all other media content-related electronic metadata distributed over the network. Network data can be divided into advertisement-related “advertisement data”, and other over-the-network available media content metadata which we will call “NMD descriptions”.

An electronic device memory is by its nature limited in size and the device's network connection has limited bandwidth. This fact creates fundamental conflict between a natural demand for metadata quality and completeness, and the device's data delivery performance and storage capacity. Guide data is developed to deliver decent quality and completeness, and at the same time keep acceptable performance and storage capacity constrains. The number of media channels and content diversification is constantly growing in our increasingly digital society. As a result, network data is continually growing and users' demand for access to more relevant data is growing as well. It would appear that the simple solution would be to expand guide data, but doing so would increase the cost of data delivery and storage and complicate the technical requirements of the electronic device.

The market is looking for alternative and more practical solutions to this problem.

There have been several attempts to provide solutions to solve this problem. One such attempt is Microsoft Media Center Edition (“MCE”) system which is software that is enabled to extract additional network data from several trusted Internet locations “on demand”. While this approach improves the search quality for certain TV events (i.e. movies and reality shows) MCE does not work wellfor other TV events (i.e. news, sport programs, educational and shopping channels, etc). An on-demand access solution such as MCE can be expensive and difficult to scale and maintain. In another attempt implemented by TiVo, a user can improve search quality by assigning personal priority tags to certain events and allowing the Tivo system to provide automatic search and recording of high-priority content. The Tivo approach of using personal priority tags increases search relevance without reliance on access to additional network data. It also does not typically require additional hardware resources or special maintenance and is generally scalable. However, Tivo's approach has its own set of problems and inherent limitations. For example, it does not produce new user information and can not generate additional knowledge about content. Additionally, it sometimes makes inaccurate conclusions regarding content relevance thereby decreasing search quality.

In yet another approach, metadata is generated via Internet search engines (i.e. Google). Internet search engines generate diversified network data that supersedes typical guide data but such an “Internet-only” approach creates a new set of problems for users. The first problem is that common search engine interfaces have been optimized for general purpose search requests and therefore are inefficient at searching the “well-structured” TV content metadata. For example, an EPG user can get a decent event description by navigating to an event name in the listings grid. Getting the same amount of descriptive information using an Internet-only approach would require entry of many keystokes by a user. The second problem is that the Internet search in this context will generate a lot of irrelevant information requiring the user to spend significant effort to separate good data from bad.

None of the existing approaches (as illustrated by the examples below) completely or effectively solves the guide data search problem. Example 1. DirecTV Tivo integrated solution provides the TV viewer with 14 days of TV schedule data for approximately 400 TV channels. Each TV program (or TV event) is described with a title, channel number, airing time, event description (episode titles, actors, director, short event overview, parental rating, star rating, genres), and airing description (sound type, close captioning, language, format, etc.). All event metadata in this solution is fairly well integrated based on a de facto standard used in the US TV industry for the last 50 years. The product allows users to search the TV schedule only inside guide data delivered overnight for the next 14 days. A user can also specify his rating of any TV event and based on such ratings the Tivo system could generate recommended shows for viewing and recording.

Limitations. While DirecTV Tivo systems improve signal strength by using personal ratings of events, they also increase the noise level because the rating information occasionally generates incorrect suggestions. The signal-noise ratio is improved on average, but not significantly. Nevertheless, cost of improvement for this system is very low.

Example 2. Microsoft Media Center Edition (MCE) provides the TV viewer with 14 days of TV schedule data. Each TV program (or TV event) is described by a title, channel number, airing time, event description (episode titles, actors, director, short event overview, parental rating, star rating, genres), and airing description (sound type, closed captioning, language, format, etc.). If the event is a movie, MCE connects to a special web-based movie database and downloads adequate auxiliary information.

Limitations. The MCE system significantly improves signal strength for events connected to Microsoft's web repository. Unfortunately this can only be done for a limited number of specific events (movies and some realty shows). It is also an expensive and non-scalable solution. While the average signal-noise ratio can be moderately improved, the cost of doing so is very high.

Example 3. Google implemented a special search engine, “Google TV”, which allows users to search for TV programs by entering a standard sequence of keywords. The current version of Google TV uses closed caption information, and channels' screenshots to provide output.

Limitations. Google TV allows a user to find information that was not available in earlier systems. However such information has a very high noise level and is limited to a few channels as well as currently airing or past events. It is not useful as an independent solution. The average signal to noise ratio is very low. Nevertheless, like many other Internet offerings Google TV is a free service.

The proposed invention solves the problems and addresses the limitations described above by creating systems that integrate existing EPG solutions with Internet Search including systems like Google TV.

### SUMMARY

The main idea of the invention is to integrate Internet-based search systems or “search engines” with existing electronic programming guides. Such integration would:
Enhance EPG user's experience by adding specially selected network data to the guide data without re-designing the guide data itself;
Enhance web TV content search by using EPG structures as a web-search navigation interface;
Allow one to create an Internet-based EPG consisting of a “thin guide client” located on the user's device using Internet search engines to generate and transfer schedule metadata.
   Based on this idea we propose a novel EPG search engine and EPG integration method and two different integrated systems:

Internet-integrated EPG (or IEPG) system that is an electronic programming guide that uses Internet search engines for enhanced event descriptions, in-line advertisements, and related communications.
EPG navigation-based Internet content search (EPGNET) system that uses EPG technologies, components, and user interface (UI) for content related search navigation.
   In one embodiment of this invention IEPG and EPGNET can converge into one unified system.

### BRIEF DESCRIPTION OF THE DRAWINGS

FIG. 1 shows a Block Diagram of an IEPG System using the Listing Module in Accordance with the present invention.

FIG. 2 shows a Block Diagram of an IEPG System using the Search Module in Accordance with the present invention.

FIG. 3 shows a Block Diagram of an EPGNET System in Accordance with the present invention.

### DETAILED DESCRIPTION

FIG. 1 describes the preferred embodiment of an IEPG system. In such a system 100 a user generates search requests 102 for the EPG Listings module 104. The output 106 of the EPG Listings module 104 is a complete description of the event generated from EPG's guide data based on user's search requests 102. The event description 106 is the input for the special module 108 called “Listings Description Analyzer”. This module receives event description, filters it, and creates a sequence of requests 110 for the Internet search engine 112. It parses and analyzes the search engine's output 114 and finally generates a new advanced event description 116. The Advanced event description 116 is later rendered on the device's screen according to the system rendering rules. In one embodiment the advanced event description 116 will be rendered separately from the event description 106. In another embodiment the event description 106 and advanced description 116 will be merged into a single description.

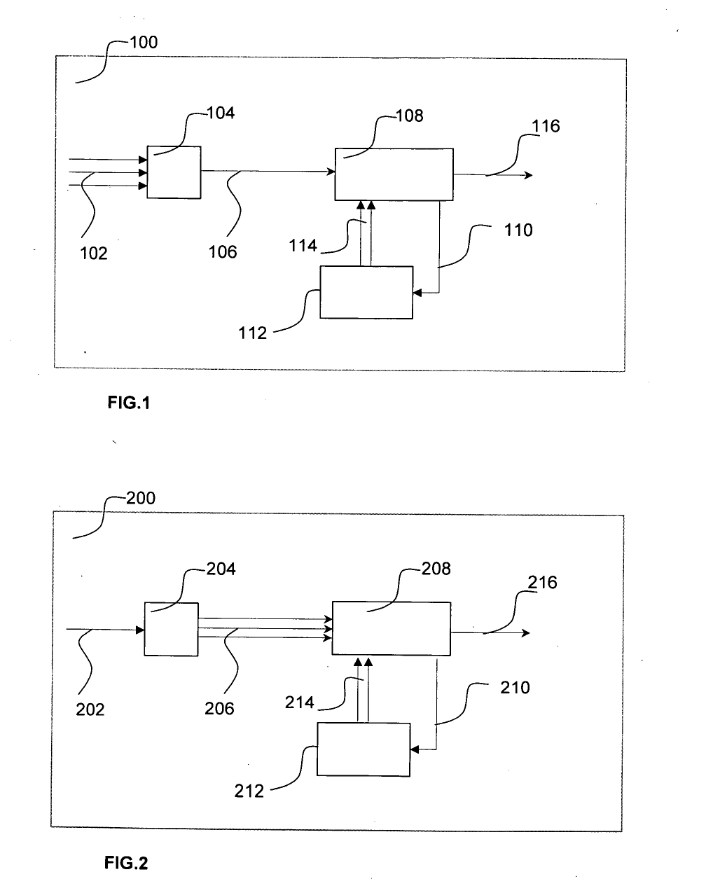

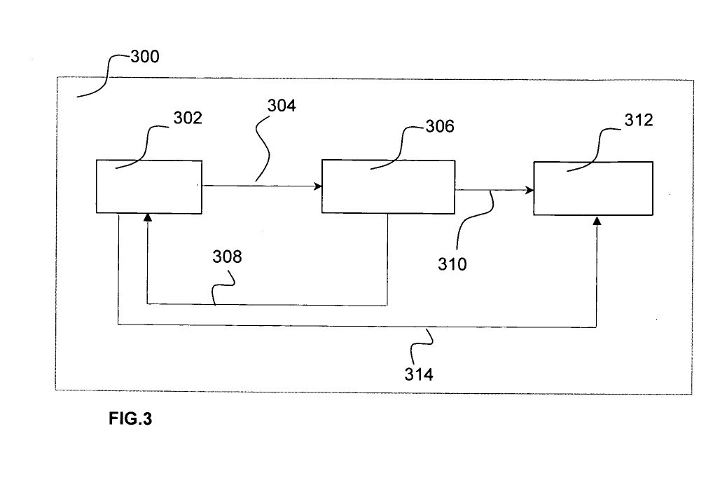

FIG. 2 describes another embodiment of the IEPG system. In such an embodiment 200 a user generates a search request 202 for the EPG Search module 204. The output 206 of the EPG Search module 204 is a set of event descriptions from the EPG guide data. The set of event descriptions 206 is used as input for the special module 208 called “Search Description Analyzer”. This module receives an event description, filters it, and creates a sequence of requests 210 to the Internet search engine 212. It parses and analyzes the search engine output 214 and finally generates a new advanced event description 216. The advanced event description 216 is later rendered on the device's screen according to the system rendering rules. In one embodiment, advanced event description 216 will be rendered separately from the event description 206. In another embodiment the event description 206 and advanced event description 216 will be merged into a single description.

FIG. 3 describes a preferred embodiment of an EPGNET system. EPGNET system 300 uses the EPG schedule control module 302 as a management front-end subsystem to the Internet search engine 306 (Internet search engine can be generic or specialized). In one embodiment module 302 allows a user to order a search of TV content with multiple criteria, including time, channel number, channel name, event title, star rating, popularity, etc. In one embodiment module 302 allows a user to initiate the search process by highlighting keywords on the device screen, for instance by highlighting TV event titles in EPG listings. Control module 302 generates special search requests 304 as inputs to the Internet search engine 306. For example, when a user highlight a “Friends” episode, module 302 could generate the primary request that includes Title, episode title, season, actor's names, like “Friends Joey's New Girlfriend Paget Brewster”. The special engine inside module 302 will take this primary request and convert it into one or more keyword sequences 304 and send them to the Internet search engine 306. The conversion engine will have its own intelligence and set of rules. The internet search engine 306 will return a set of reference sides to module 302. The special reference side analysis engine inside module 302 will consolidate the results, generate output data 314 and move it to the rendering engine 312. The same engine 312 will also enter search engine outputs 310 directly.

The IEPG and EPGNET systems described above can be used to enhance other media data, including but not limited to radio, imaging, music, etc.

Additional Embodiments.

In one embodiment of this invention, the proposed system can be integrated with a personal rating assignment subsystem. This subsystem will allow a user to assign special “quality grade” to TV events based on the user's individual preferences.

In one embodiment of this invention, the proposed system can be integrated with a group-based rating assignment system. This subsystem will assign special “quality grades” to TV events based on ratings created by other users.

I claim:

1. A method for conducting media content search and management comprising:
electronic programming guide (EPG); and an Internet search system; and a subsystem for collecting EPG Listing information over the Internet; and filter for creating said special search requests; and filter for parsing and analysis of said search system's search results; and results rendering subsystem of said search results.

2. The method of claim 1 wherein said electronic programming guide (EPG) is generated at the client system.

3. The method of claim 1 wherein said electronic programming guide (EPG) is generated at the server system.

4. The method of claim 1 wherein said Internet search system comprises of a single search engine.

5. The method of claim 1 wherein said Internet search system comprises of multiple search engines.

6. The method of claim 1 wherein said subsystem for collecting EPG Listings information over the Internet includes special search requests to said Internet search system.

7. An apparatus comprising: EPG Listings generation pipeline; and said EPG Listings generation pipeline
Internet Search system mean; and said EPG Listings generation pipeline Internet EPG data collecting mean; and said EPG Listings generation pipeline filter for creating special request mean; and said EPG Listing generation pipeline filter for parsing and analysis of collected mean; and said EPG Listings generation pipeline screen rendering mean.

8. The apparatus of claim 7 wherein said Internet Search system mean comprises a single search engine.

9. The apparatus of claim 7 wherein said Internet Search system mean comprises of more than one search engines.

10. The apparatus of claim 7 wherein said EPG Listings generation pipeline mean comprises EPG rendering mean.

11. The apparatus of claim 9 wherein said Internet Search system mean comprises search results aggregation mean.

12. The apparatus of claim 9 wherein said Internet Search system mean comprises search request filter mean.
